(19) United States
(12) Patent Application Publication
(10) Pub. No.: US 2014/0366164 A1
(43) Pub. Date: Dec. 11, 2014

(54) REMOTELY ACTUATED DISPLAY SYSTEM AND RELATED METHODS

(71) Applicant: DCI Marketing, Inc., Milwaukee, WI (US)

(72) Inventors: James Hoefgen, Wauwatosa, WI (US); Andrew Dunkerley, Leicestershire (GB); Sam Saha, Milwaukee, WI (US); Christopher J. Turner, Pewaukee, WI (US)

(21) Appl. No.: 14/297,523

(22) Filed: Jun. 5, 2014

Related U.S. Application Data
(60) Provisional application No. 61/831,343, filed on Jun. 5, 2013.

(51) Int. Cl. G06F 21/84

(52) U.S. Cl. CPC G06F 21/84
USPC 726/34

(57) ABSTRACT

A remotely articulated display system for displaying an electronic device has a locking mechanism that is controlled by software installed on the electronic device. The software installed on the electronic device requires a user to supply an authorization input to lock and unlock the electronic device from the display system. Related methods are also disclosed herein, e.g., methods of remotely locking a display via software stored on the device being displayed, methods of locking a display via a multi-stage lock, etc.

### CROSS-REFERENCE TO RELATED APPLICATION

The application claims the benefit of U.S. Provisional Application No. 61/831,343, filed Jun. 5, 2013, and is incorporated herein by reference in its entirety.

### FIELD OF THE INVENTION

The present invention relates generally to the field of mobile device security displays. More particularly, the present invention relates to a security display device for displaying, powering, charging, and securing a device that includes a lock mechanism controlled by software present on the device.

### BACKGROUND

In the field of mobile device security systems, there is a need to display small electronic items, such as cell-phones and tablet computers in a way that allows a dynamic number of authorized users to quickly and easily remove the secured device from a display base and re-secure the device at a later time.

Most conventional security solutions tether the electronic device to a base so that the device may be removed from the base for closer inspection and feel, but keep a cable tether connected to the electronic device to limit the range of movement of the electronic device so as to hinder theft of the device. For example, existing security solutions typically use a base with a retractable wire cable that is connected to the retractor and base on one end and that connects to the electronic device on the other end via an adhesive pad or jaw mechanism. In some forms, a power cable is also provided to supply power to the electronic device. The power cord may wrap about the wire cable and/or retract with the wire cable, or the power cord can connect separately to the electronic device.

If not designed carefully, the use of such tethers can negatively impact a consumer's impression of the electronic device and cause the retailer to potentially lose out on a sale. For example, if the tether is difficult to use the consumer is less likely to buy the electronic product. In some instances, the user may associate some difficulty with the tether as a negative aspect of the actual electronic product which may also result in a lost sale.

Attempts have been made to provide wireless security solutions for portable electronic devices, but these typically require use of dedicated circuitry or physical components on both the electronic device and the base or security solution network the electronic device is normally stationed at or connected to when not being used or inspected by a consumer. For example, some conventional solutions utilize circuitry dedicated to the security solution itself so that an audible alarm is generated from the circuitry if it is removed from a predetermined vicinity or beyond a predetermined distance from the base or the security solution network to which the device and/or base are connected. Typically, the dedicated circuitry will include a housing or structure connected to the electronic device (e.g., a remote unit) containing the speaker and a transmitter, receiver or transceiver for transmitting and/or receiving a signal to or from the security system. Likewise, the base or security solution network will have additional circuitry for communicating with the remote unit. Although the audible alarm in this configuration would be generated from the remote unit, in some forms the security solution is configured with an audible alarm device, such as a speaker, connected to the base or security solution network either in addition to the audible alarm located on the remote unit or in lieu of the audible alarm located on the remote unit. Regardless, such additional components (e.g., circuitry dedicated to the security solution) typically increase the cost of the overall security solution and still present the problem that the solution will make the electronic device more difficult to use and/or cause the consumer to associate some negative issue to the electronic device when in fact it pertains to the security solution.

Accordingly, it has been determined that the need exists for an improved security solution and method for securing portable electronic devices which overcome the aforementioned limitations and which further provide capabilities, features and functions, not available in current devices or security solution systems.

### SUMMARY

A remotely actuated display system is disclosed herein having a base for securely mounting a device and including a receptacle and a locking mechanism, the receptacle removably attached to an electric power source, a case removeably attached to an electronic device and including a hub which is removably attached to the receptacle, the hub including a controller communicatively attached to the electronic device and further including a plurality of recesses for receiving at least a portion of the locking mechanism, and the electronic device including a software application for controlling the locking mechanism.

In another form, a remotely actuated display or security solution apparatus is disclosed having a cover for covering at least a portion of a portable electronic device, a locking mechanism having a body and at least one lock, the lock being moveable between a locked position and unlocked position via a control interface for use by a user to interact with the remotely actuated display or security solution apparatus and a controller configured to unlock the locking mechanism in response to an authorized input being entered on the control interface.

Such a security solution or display would be helpful in numerous areas of industry, such as retail sales and service industries. For example, one common situation where such a display would be used is in an automobile dealership. Tablet computers are a valuable, if expensive, sales tool that can be used by a salesman to enhance the car buying experience by providing the salesman with a huge wealth of information not available in a brochure. Additionally, the sales experience may be enhanced by allowing the salesman to configure a virtual car for a customer while they are looking at a vehicle in the showroom or on the dealer parking lot. While the tablet computer is not being used in a sales capacity, it is advantageous to display the tablet in a conspicuous location in the showroom where prospective buyers could view information about the cars being sold and even create their own configuration. However, leaving the tablet computer on a display where a customer can use the tablet raises the possibility of theft of the device if the device is not secured to the display.

Presently available security systems make completely removing the device from a base extremely difficult. Typical security display devices include a tether that is attached to a device by either a mechanical or adhesive attachment. Of course, including a tether makes the contemplated use by a salesperson impossible. As a result, there is a need for a security display system that allows a salesperson or other authorized user to quickly and easily remove a device from the display without using an external key, yet also secure the device when it is mounted to the display so that an unauthorized user cannot remove the device from the display.

Another common use of mobile device security systems is in retail environments where consumers are able to interact with the devices being displayed without consulting a sales associate, such as for example, consumer electronics retailers. Retailers want to allow potential customers to be able to use the devices in the store, but lack the staffing and/or security to allow them to do so without fear of rampant theft. In order to facilitate customer interaction with the devices while simultaneously preventing theft, retailers employ a wide variety of security measures.

As mentioned above, one common solution to the above problem has been to anchor the item to a shelf, table, wall, or display. Retailers have implemented a wide range of anchors that may provide power to the device and/or include alarm capabilities in the event that the device is removed from the anchor without authorization. Typically, special tools or keys must be used to remove the device from the anchor if it needs to be removed or replaced. The mechanical attachment to the base may be locked or unlocked by a variety of keys, but all require the operator to have a physical key to unlock the device from the base.

Other common areas where such security solutions or displays would be useful are in any service industry (e.g., the health care industry, education industry, hospitality industry, such as hotels and restaurants, other professionals, etc.). For example, some uses of mobile device security systems contemplated herein include use in hospitals or schools where a large number of users may need access to a limited number of mobile devices. In such uses, the users of mobile devices may be doctors and nurses, or teachers and students, each of which may need varying degrees of access to the mobile devices. Presently, mobile devices typically do not include multiple profiles for multiple users as is common with computers. It would be advantageous, therefore, to be able to provide access to members of many disparate groups of users of mobile devices, wherein the level of access is controlled by software installed on the devices. For example, portable electronic devices may be kept in a display like those disclosed herein at a station (e.g., nursing station, doctor station, etc.) so that the device can be unlocked and used by a healthcare professional with a patient and then returned to the base to charge and/or securely store the electronic device until it is checked out by the next individual.

Similarly, such security solutions or displays may be useful in the hospitality industry. For example, in some hotel applications it is desirable to allow the device to be removed from its base or anchor at times and then returned to the base or anchor for securing the electronic device and/or charging same. In one form, displays such as those disclosed herein may be utilized by front desk personnel for different tasks. For example, if check-in lines get long, extra employees may unlock tablets from their secured display bases or anchors and go assist in checking-in people waiting in line and then return the device to the base or anchor to secure the tablet and/or charge same. The returned device may then serve as an additional resource or tool for guests to use even when installed in the secured display base. For example, after peak check-in, employees may return the tablets to their bases on a desk, table or wall which other guests may make use of either while the device is installed on the base (e.g., to get further information about the hotel or surrounding area, to access the internet, book spa or other appointments, etc.) or by removing the device from its base using their room number or an assigned personal identification number (PIN) to allow the guest to take and use the device in a lobby area, a business center, or elsewhere (e.g., such as to read a paper or check the Internet on a lobby couch, access personal or work email via the tablet in a business center or personal cubical/carol, etc.).

In another example, a front desk employee may wish to use the secured display disclosed herein to rotate the screen of a tablet to show a guest something (e.g., a map of the premises, certain accommodations of the hotel, explain directions to a particular destination, etc.) and/or remove the device so that it can be passed back and forth between the employee and guest as needed or desired. Such devices may also be used for concierge services and/or for in-room services (e.g., allowing a guest to remove and use the electronic device either for a fee or as a complementary service of the hotel or hotel chain).

In other hospitality applications such as restaurants, security solutions such as those disclosed herein may be utilized by staff to remove an electronic device for remote usage and securely store the device on a base when not in use remotely by the staff. For example, in some applications, a waiter may remove a table from one of the displays disclosed herein to give to a guest for use as a menu or for showing the guest various dishes offered by the restaurant, and then can return the device to its base to charge and to secure the electronic device and prevent theft of same. In other examples, such a display may be utilized for customer interaction (e.g., to display and/or review menu items, allow for self-ordering and/or checkout by the customer, allow for customer participation in a loyalty program, allow for game or music play by the customer while dining, allow for other entertainment while dining such as providing Internet access, etc.).

Additionally, the ability to remove the devices from the anchor may also be important in a retail environment if and when the store wishes to re-planogram. As used herein “planogram” refers to a diagram of fixtures and products that illustrates how and where retail products should be displayed to increase customer purchases. In the rapidly changing world of cell phones and small electronics, the retailer's ability to quickly and easily move products around the retail environment without damaging the products or the displays is extremely important.

As such, there is a need for an anchor for displaying items that not only provides power to the device and secures it to a base, but also includes software on the device that controls a locking mechanism and allows stores to be easily and quickly reconfigured without damaging the small item or the anchor. Additionally, in one embodiment, the software may track and audit the usage of the device and charge level of the device while it is mounted to the base.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of one embodiment of a remotely actuated display system in accordance with the invention showing a tablet computer secured to a base;

FIG. 2 is a partially exploded perspective front view of one embodiment of a case in accordance with the invention showing how the case is a two-piece case and is attached to a tablet computer;

FIG. 3 is a partially exploded rear perspective view of the case of FIG. 2 showing the back of the case and tablet computer;

FIG. 4 is a perspective view of one embodiment of a base in accordance with the invention;

FIG. 5 is a section view of the remotely actuated display system of FIG. 1 taken generally along the line 5-5 in FIG. 1 showing one embodiment of a locking mechanism in accordance with the invention;

FIG. 6 is a partial section detail view of another embodiment of a locking mechanism in accordance with the invention;

FIG. 7 is a schematic of one embodiment of a remotely actuated display system in accordance with the invention;

FIG. 8 is a flow chart of one embodiment of the process flow for attaching a device to a base in accordance with the invention;

FIG. 9 is a flow chart of one embodiment of the process flow for removing a device from a base in accordance with the invention;

FIG. 10 is a partially exploded perspective view of another embodiment of a case in accordance with the invention illustrating a multi-piece or part cover;

FIG. 11 is another partially exploded view of the case of FIG. 10 showing how the case is attached to a tablet computer and illustrating the center piece of the cover exploded so that a controller and device connector are visible;

FIG. 12 is a front view of the case of FIG. 10;

FIG. 13 is a back view of the case of FIG. 10;

FIG. 14 is a top view of one embodiment of a locking mechanism in accordance with the invention;

FIG. 15 is a perspective view of the locking mechanism of FIG. 14 showing a hub attached to the locking mechanism;

FIG. 16 is an exploded view of the locking mechanism of FIG. 14;

FIG. 17 is a top view of the locking mechanism of FIG. 14 showing the hub portion of the cover attached to the locking mechanism;

FIG. 18A is a section view of the locking mechanism of FIG. 14 taken generally along line A-A of FIG. 17;

FIG. 18B is another section view of the locking mechanism of FIG. 14 taken generally along line B-B of FIG. 17;

FIG. 19 is a front view of the locking mechanism of FIG. 14;

FIG. 20 is a perspective view of the front of an alternate embodiment for the cover of the security solution;

FIG. 21 is a perspective view of the rear of the cover of FIG. 20;

FIG. 22 is an exploded view of the cover of FIGS. 20 and 21 illustrating the first, second and third cover portions and a hub cover that connects to the cover once the three portions are connected to one another;

FIG. 23 is a perspective view of an alternate locking mechanism and base for use with the cover of FIGS. 20-22;

FIG. 24 is an exploded view of the locking mechanism and base of FIG. 23 illustrating the base cover and locking mechanism cover exploded from the remainder of the base and locking mechanism;

FIG. 25 is an exploded view of the locking mechanism and base of FIG. 23 illustrating just the base cover exploded from the remainder of the base and locking mechanism;

FIG. 26 is an exploded view of the locking mechanism and base of FIG. 23 as viewed from below and with the locking mechanism removed from the lower base portion and illustrating a tool for releasing the base cover from the remainder of the base to provide access to the fasteners that secure the base and/or locking mechanism to a work surface; and

FIG. 27 is an exploded view of the entire locking mechanism and base of FIG. 23.

### DETAILED DESCRIPTION

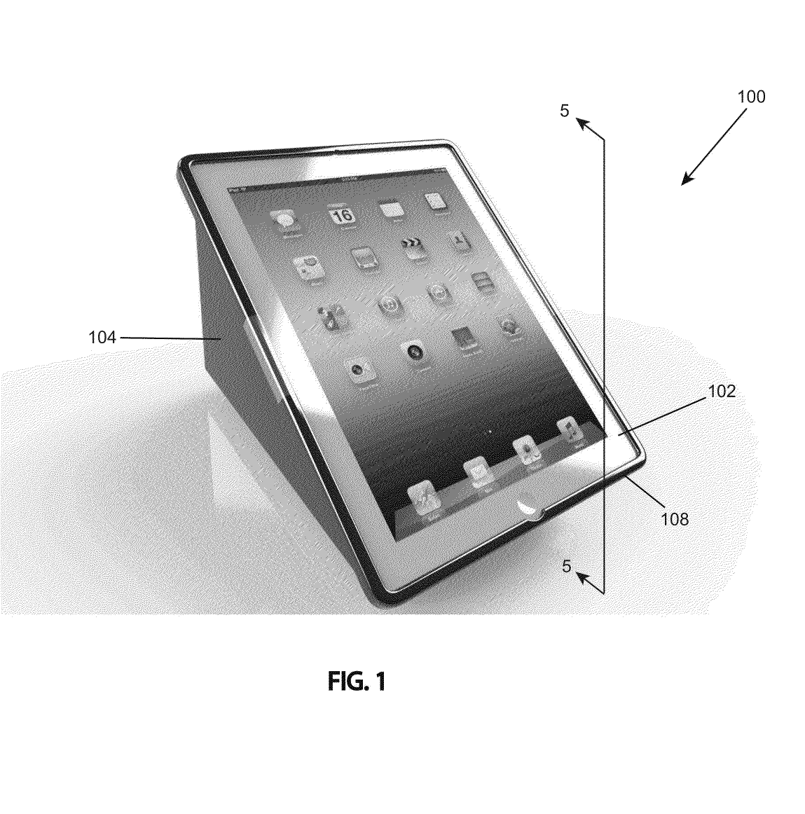

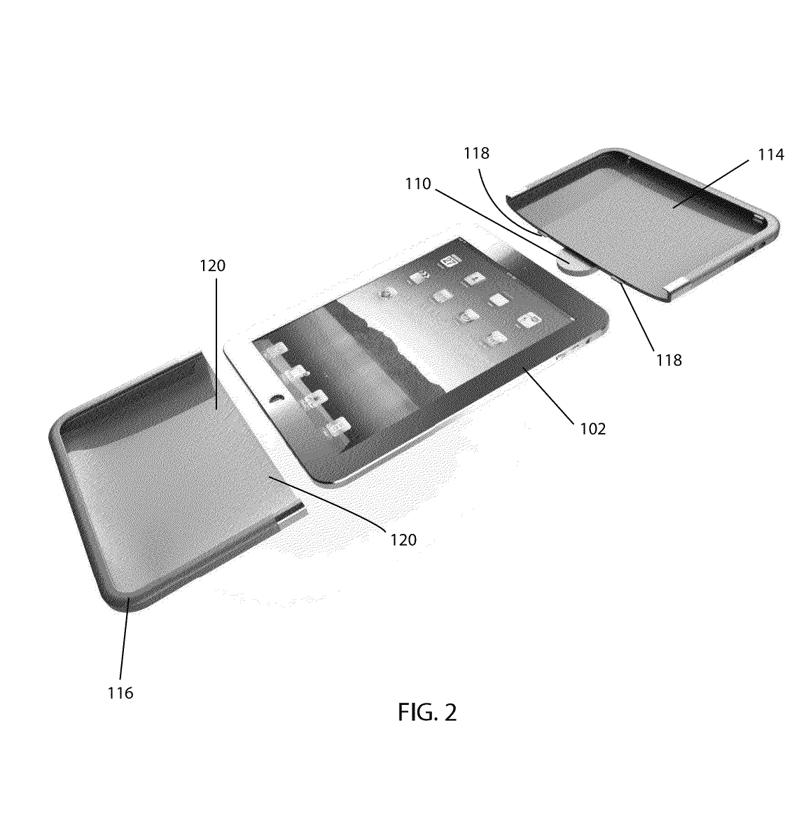

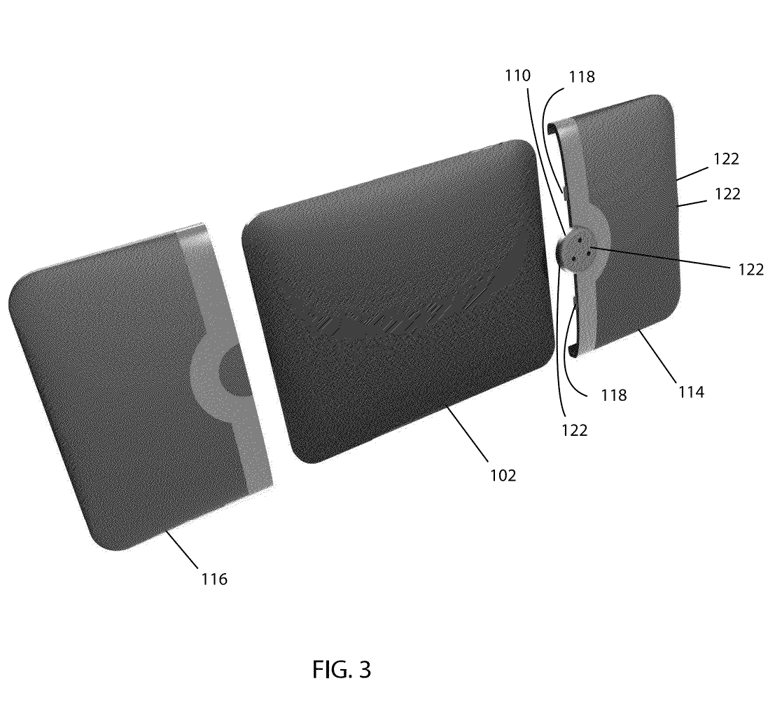

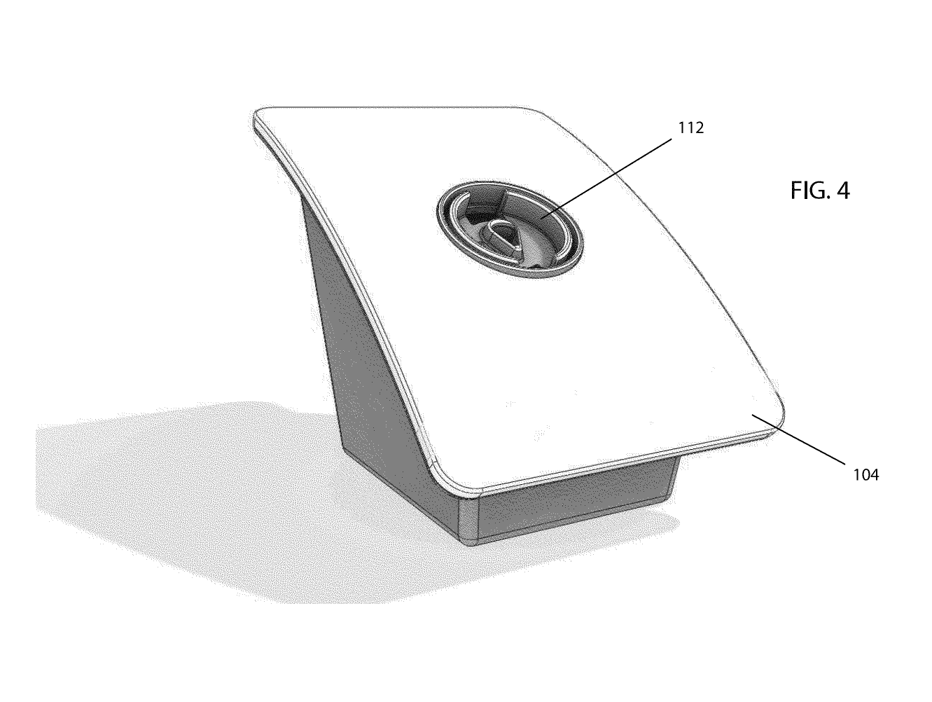

Turning first to FIGS. 1-4, one embodiment of a remotely actuated display system 100 in accordance with the invention is shown. In the embodiment shown, a device 102 (e.g., such as an electronic device like a mobile phone, tablet, hybrid tablet laptop or convertible, laptops, etc.) is removably attached to a base 104 by a locking mechanism 106. The locking mechanism 106 includes a case 108 that removably encases the device 102 and provides a first locking or mating member, such as hub 110, that engages a second locking or mating member, such as receptacle 112, on or in the base. Although the device 102 shown is a tablet computer, any suitable device may be secured to the base 104 as disclosed herein without departing from the invention. As will be described, the device includes software that allows the device to communicate with and control the locking mechanism 106.

In the embodiment shown, the case 108 has a first securing member, such as upper portion 114 and a second securing member, such as lower portion 116. The upper portion 114 includes a plurality of protrusions, such as resilient tabs 118, that engage corresponding and mating recesses 120 in the lower portion 116 when the upper and lower portions are installed onto the device, thereby securing the case 108 to the device. Of course, the case 108 may encase the device 102 by any suitable means without departing from the invention. In other embodiments, the recesses and protrusions may be swapped on the securing members or each securing member may have one or more of both the recesses and protrusions (e.g., an alternating configuration). In still other embodiments, the case 108 may be made of more or less parts as long as the hub 110 is secured in a suitable alignment on the device 102. Alternatively, a hub 110 may be directly attached to the device 102 by any suitable means including but not limited to adhesive and/or with locking jaw members with jaws positionable or translatable with respect to each other or at least one jaw member being moveable with respect to the other.

The case 108 also electronically engages the device 102, allowing the device to be powered and/or charged when it is attached to the base 104. In the embodiment shown, the hub 110 electrically engages the receptacle 112, thereby providing electric power to the device 102. In alternative embodiments, the device 102 may be powered and/or charged by induction or any other suitable means without departing from the invention. In the embodiment shown, the base 104 does not communicate any data to the device 102, but in alternative embodiments the base may include communications circuitry (e.g., transmitter, receiver, transceiver, display, one or more inputs, etc.) that would allow data to be transmitted between the base and the device (e.g., wirelessly via Radio Frequency (RF) such as Bluetooth (BT), Infrared (IR), Near Field Communication (NFC), wireless local area network (WLAN/Wi-Fi), etc. or wired such as serial communication cable, BUS, etc.) or the device and a network to provide information relating to the device (e.g., who used device, how long, how device was used, information regarding consumer, retail science information, etc.). The electronic engagement of the device 102 by the case 108 is achieved by any suitable means. In still other embodiments, the base 104 may not power and/or charge the device 102. In such embodiments, the base 104 may still be electrically connected to the device 102, thereby allowing a locking or unlocking signal to travel from the device to the base.

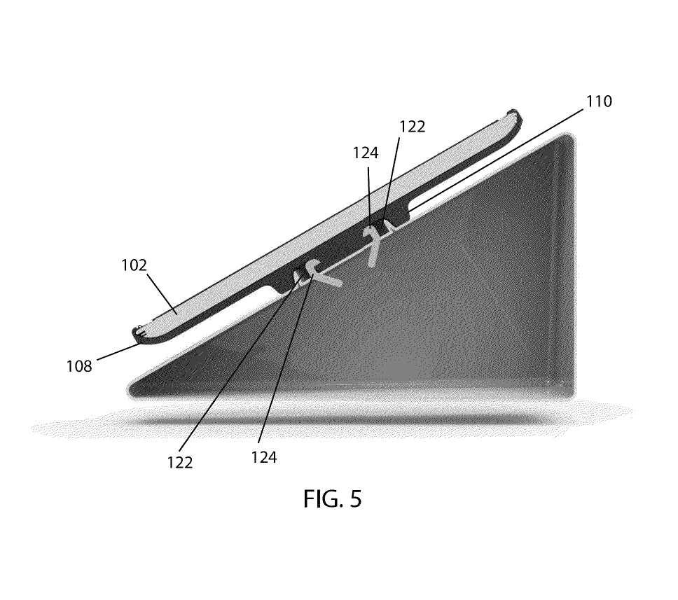

In one form, and as illustrated, the hub 110 may include a plurality of recesses 122 that protrusions such as locking arms 124 (see FIG. 5) engage when the hub 110 is secured to the base 104. Alternatively, any suitable locking means may be used (e.g., mating male and female structures, magnetic structures, fasteners such as pivoting bolts, clasps, etc.) and any number of these items may be used (e.g., one or more locks may be used). The hub 110 may also include alignment features that engage corresponding features in the receptacle 112 to orientate the device or ensure the device 102 is displayed in a desired orientation when secured to the base 104. In alternate forms, the position of the recesses 122 and locking arms 124 may be reversed so that the base moves the recesses into and out of engagement with the hub or alternating recesses and protrusions on both the hub 110 and base 104 may be used that mate with one another to secure the components together when desired. Alternate mating structures may be used as well, such as: tongue and groove, corresponding first and second mating members, etc. In still other forms, the hub or other portions of cover or case 108 may contain moveable members that lock the device to base.

Turning now to FIG. 5, a cross-section of the remotely actuated display system 100 of FIGS. 1-4 is shown. In this form, the locking aims 124 are shown engaged with the recesses 122. The locking arms 124 are retractable, which allows the device 102 to be removed from the base 104 when the locking mechanism 106 is unlocked. Retraction may be accomplished mechanically, through rotation of gears, drives, shafts or the like, or alternatively may be accomplished electrically or electro-mechanically via magnets, solenoids, or the like.

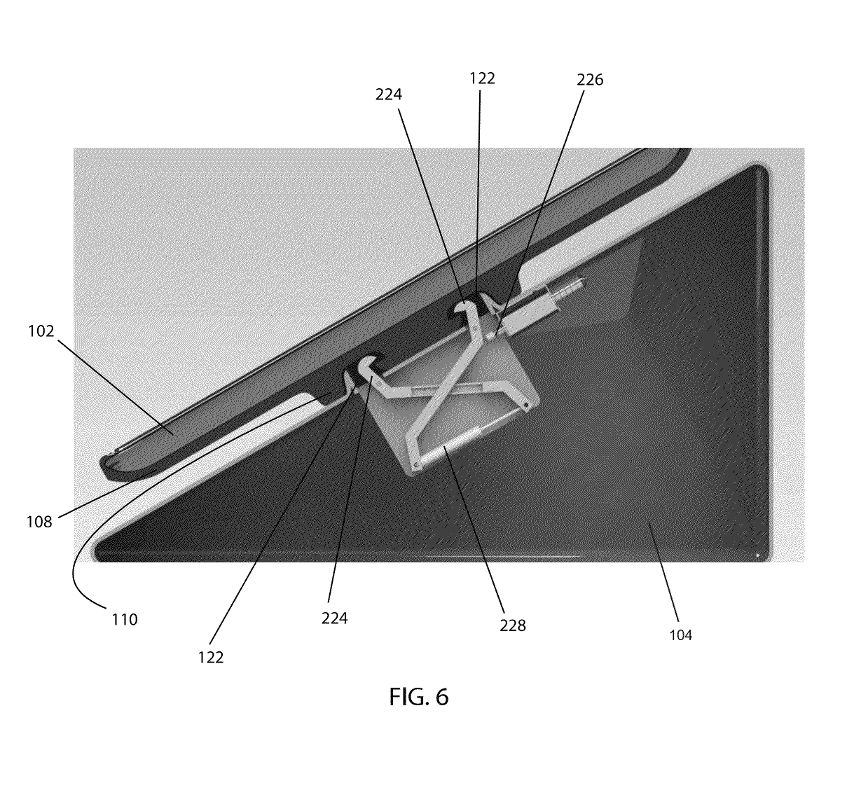

FIG. 6 shows an alternative embodiment of the security solution or display 100, illustrating an alternative locking mechanism for same. For convenience, items that are similar to those discussed above will use the same reference numeral and items that differ will use a similar latter two-digit reference number, but increment the hundreds integer by one to distinguish one embodiment from others. Thus, the locking arms in FIG. 6 will be referenced as 224 instead of 124. In the form illustrated, alternate mating members such as protrusions or locking arms 224 engaged with the mating recesses 122. The embodiment shown in FIG. 6 further includes a biasing mechanism, such as spring loaded pin 226, which provides a positive locking force (e.g., pressure) onto the locking aims 224, which ensures engagement of the locking arms 224 with the recesses 122 when the hub 110 is inserted into the receptacle 112. When the remotely actuated display system 100 is unlocked, an actuator 228 releases the locking arms 224 from the recesses 122 so that the device 102 may be removed from the base 104.

In the form illustrated, the actuator 228 is a solenoid that is activated or energized to temporarily retract locking arms 224 from the mating structures (e.g., recesses or shoulder members) located in hub 110. Specifically, upon entry of an authorized command, solenoid 228 is activated or energized to move the ends of locking arms 224 connected to the solenoid 228 in a first or unlocking direction (e.g., toward one another or closer together) to disengage or unlock the hub 110 from the base or anchor 104). After a predetermined amount of time has passed, the solenoid 228 is de-activated or de-energized to move the ends of locking arms 224 connected to the solenoid 228 in a second or locking direction (e.g., away from one another or farther apart) to cause the distal ends of the locking arms 224 to return to their normally biased locking position wherein they would engage the hub 110 if present.

It should be understood that in alternate embodiments, any other suitable unlocking mechanism may be used without departing from the invention. For example, in an alternate form, a negative locking force may be utilized such as a magnetic force that attracts locking members to secure the device and repels the locking members to unlock, or vice versa. Thus, in addition to utilizing positive and negative locking forces, the device may include mechanical or non-mechanical (e.g., electric or electronic) or electro-mechanical locking members for securing an electronic device to the display, or may utilize both mechanical and non-mechanical securing mechanisms. For example, in some forms actuators 228 may be struts or other structures that resist compression (e.g., longitudinal compression) and normally bias the locking arms 224 in a locked position. It should also be understood that in alternate forms, the actuator 228 may keep the locking mechanism in the unlocked position until a second locking command is received instead of only temporarily unlocking the locking mechanism. Similarly, it should be understood that the security solution 100 could be setup to only require momentary communication with the actuator 228 to lock and/or unlock the locking mechanism or, alternatively, could be setup to require continual communication with the actuator 228 to lock and/or unlock the locking mechanism. Momentary communication is preferred, however, for energy saving purposes. For example, in preferred forms, the user would only need to enter an authorized input once and the circuit issue a corresponding unlock comment once in order to unlock the hub 110 from base 104. In alternate forms, however, it may be desired to either require the user to continually depress an input to generate an authorized input and/or for the circuitry to continuously hold an integrated circuit pin high or low in order to keep the locking mechanism in the unlocked position.

Turning now to FIG. 7, one embodiment of a remotely actuated display system 100 in accordance with the invention is shown. Each device 102, depending upon its operating system, will require an installed software program (e.g., an app) to function according to the specifications of locking software that will control the locking mechanism 106. The software program includes an interface to allow the user to enter an authorization signal or input (e.g., identification code, password, biometric input, voice command, authentication gesture, etc.) which may be used to release the device 102 from the base 104. In one form, an identification code will be used to authenticate information based upon an encrypted key pattern stored within a valid list of responses. In the embodiment shown, the authorization input is an alphanumeric sequence of characters, but any authorization input may be used without departing from the invention (e.g., password, gestures, biometric input, voice recognition, alphabetic sequence alone, numeric sequence alone, etc.). Such identification code or codes may include but are not limited to active authentication such as requiring the user to make one or more gestures, or passive authentication such as using a front facing camera on the device to recognize the face of the user (e.g., conducting a retinal scan), detect the presence of a person, detect a biometric identifier such as a finger or palm print, using the camera or, alternatively, a motion sensor to detect a gesture, or any other input or combination of inputs the device is capable of interpreting. In one form, the software program may also be configured to allow locking or unlocking of the device 102 without using an encrypted authorization input. Such non-encrypted locking and unlocking may be achieved by simply tapping a virtual button on the device 102 (or providing any of the other types of inputs discussed above), and may be preferred in instances where the system 100 is installed in an otherwise secure environment or in a location such as a home. In another form, non-encrypted locking may be used to simply lock the device and only require an authorization input to unlock. In still other forms, the locking may be done automatically (e.g., immediately locking the device when it is returned to the display, automatically locking after it has been returned to the display for a predetermined period of time).

When a user inputs a valid authorization input, such as a valid identification code, a communication exchange between a controller, such as micro-controller 3636130 and locking mechanism 106 will be transmitted to actuate and release the device 102 from the base 104. As shown in the form illustrated, the transmission of information between the micro-controller 3636130 and the locking mechanism 106 is with a wired connection, but any suitable means such as a wireless connection may also be used (e.g., RF, BT, NFC, etc.). In the embodiment shown, the device 102 may record and compile data received from the micro-controller 3636130 including but not limited to the status of each base 104, the state of charge of a device 102, and/or data relating to the device 102 (e.g., usage, battery power, apps accessed, websites visited, products looked at, or other available data, such as cookies and the like).

The micro-controller 3636130 may also be connected to a remote computer or network that may control one or more micro-controllers for other such security devices in a display system. The connection between the micro-controller 3636130 and the remote computer may be by any suitable means such as wireless or wired (e.g., serial BUS, RF, BT, NFC, etc.) and the network may be any type of suitable network (e.g., PANs, MANs, LANs, WANs (like the Internet), IANs (like cloud based networks), etc. The remote computer may also record and compile data received from the micro-controller 3636130 similar to the data previously described as being stored on the device 102. In alternate embodiments, the device itself could be used to only lock or unlock the device to the base rather than doing both the locking and unlocking, or in still other forms, the base may be configured with an input for allowing the locking and/or unlocking to be done independent of the device.

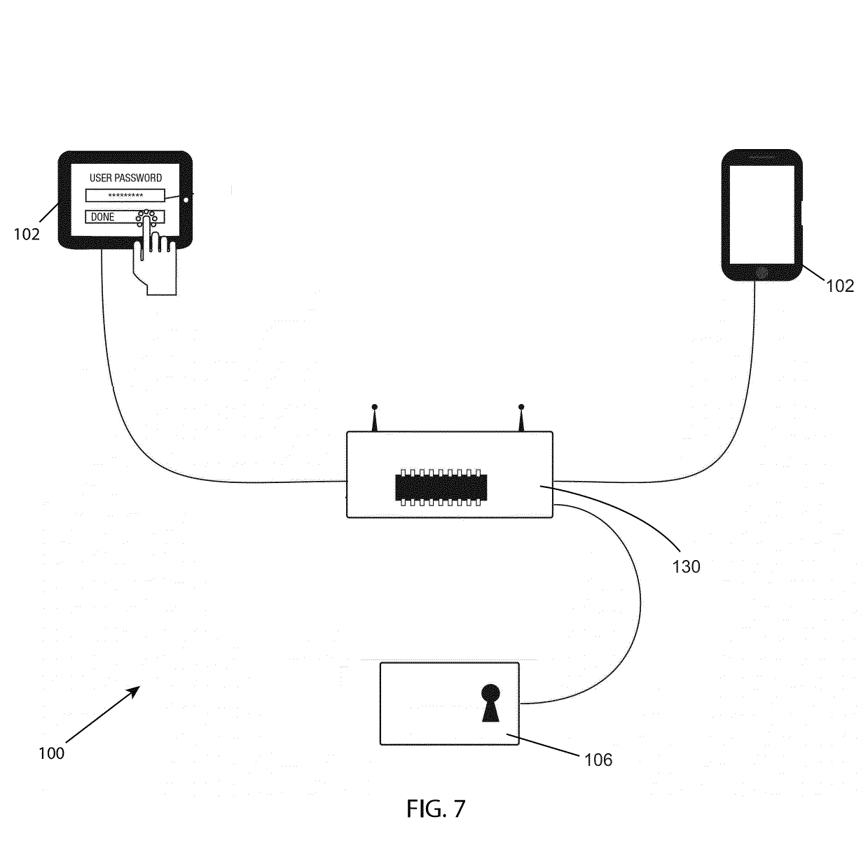

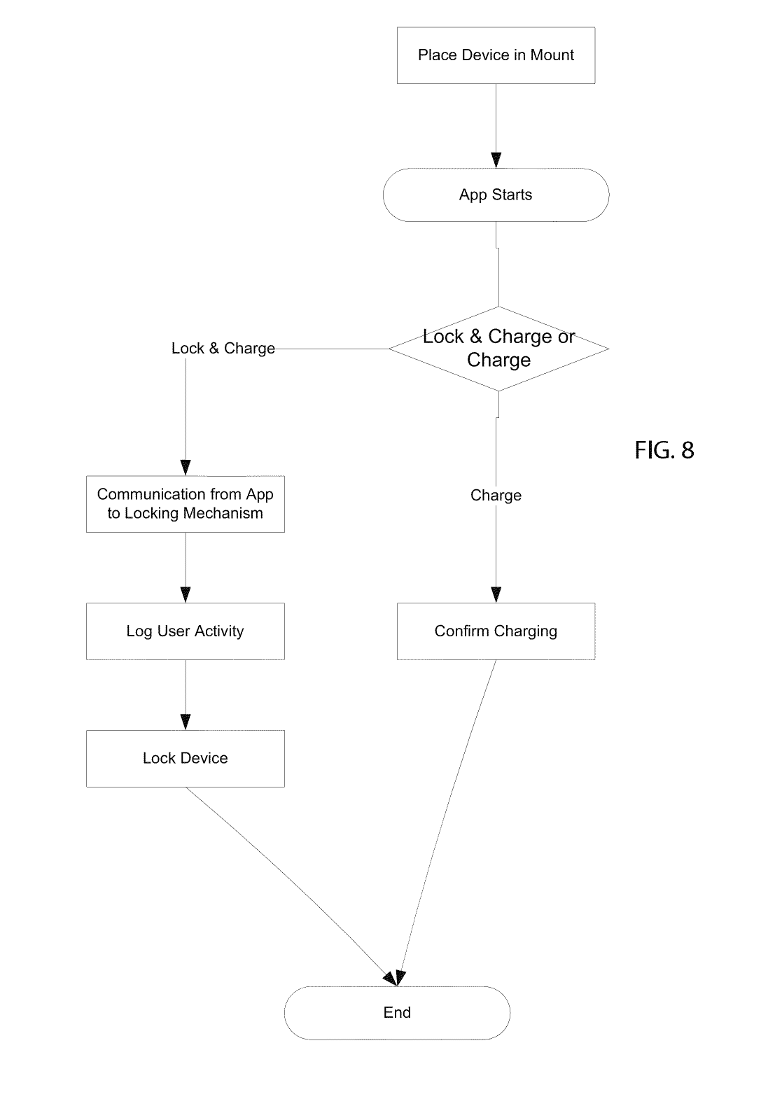

Turning now to FIG. 8, an exemplary device mounting process flow in accordance with the invention is shown. In this form, when a user mounts a device 102 to the base 104, the microcontroller senses that the device 102 is mounted to the base. The software program on the device 102 automatically starts when the device is mounted to the base 104. In alternative embodiments, the user may manually start the software program instead. The software program prompts the user to select whether he or she would like to lock and charge the device 102 or merely charge the device without locking it to the base 104. The user makes his or her selection and the locking mechanism 106 either locks the device 102 to the base 104 or does nothing. If the user selects to lock the device 102 to the base 104, the software program logs the activity into the memory of the device and communicates to the micro-controller 3636130 actuates the locking mechanism 106, thereby securing the device to the base. Of course, the activity may be logged remotely as well. In alternate forms, the data may be stored in an external memory location, such as in remote memory accessed via a network (e.g., a cloud network, etc.). The remote memory could be located on or in the security system's base, the main computer or hard drive for the system (if a larger multi-device display), etc.

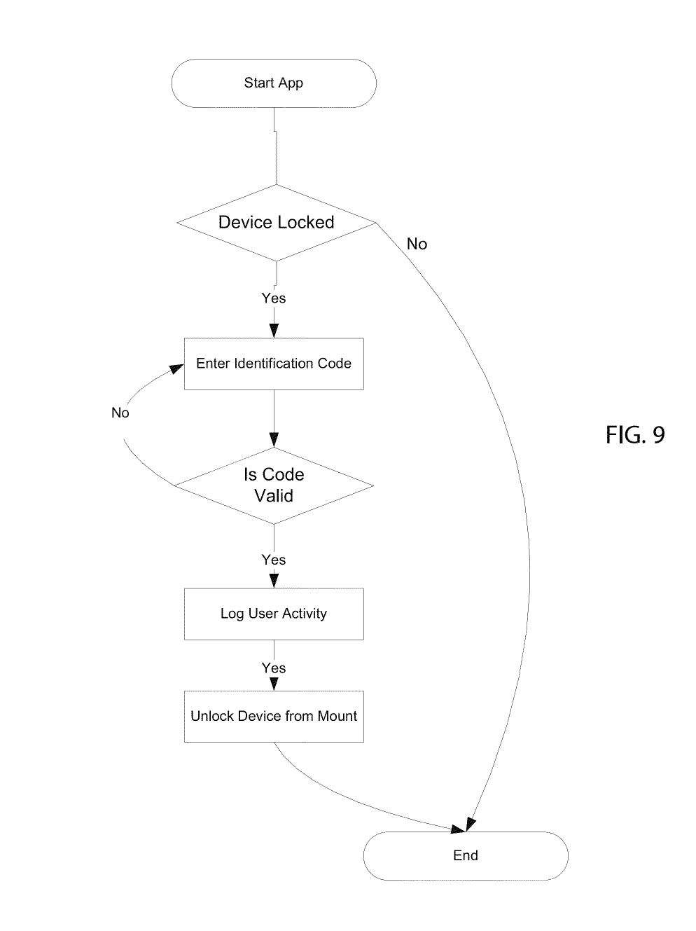

FIG. 9 shows an exemplary process flow for removing the device 102 from the base 104. First, a user opens the software program (e.g., app, etc.) on the device 102. If the locking mechanism 106 is unlocked, the user may simply lift the device 102 off of the base 104. If the locking mechanism 106 is locked, the software program will prompt the user to enter an authorization input (e.g., identification code, etc.) which, if valid, will unlock the locking mechanism 106 and log the activity in the memory of the device 102. As in the locking sequence described above, the system may log user data remotely as well without departing from the invention.

The authorization input described above may be any unique input, which may be assigned by device, user, store, or in any other fashion (e.g., assigned via rolling code, assigned by OEM or dealer/distributor, etc.). By assigning codes in different ways, a user may monitor usage of the device 102 and locking mechanism 106 in a wide variety of ways which may be customized on a case by case basis. For example, a different authorization input may be assigned to each sales person so that information regarding each sales person's use (e.g., who unlocked the device, how long did they have it checked out, what did they do or access while they had it, etc.) can be tracked or monitored.

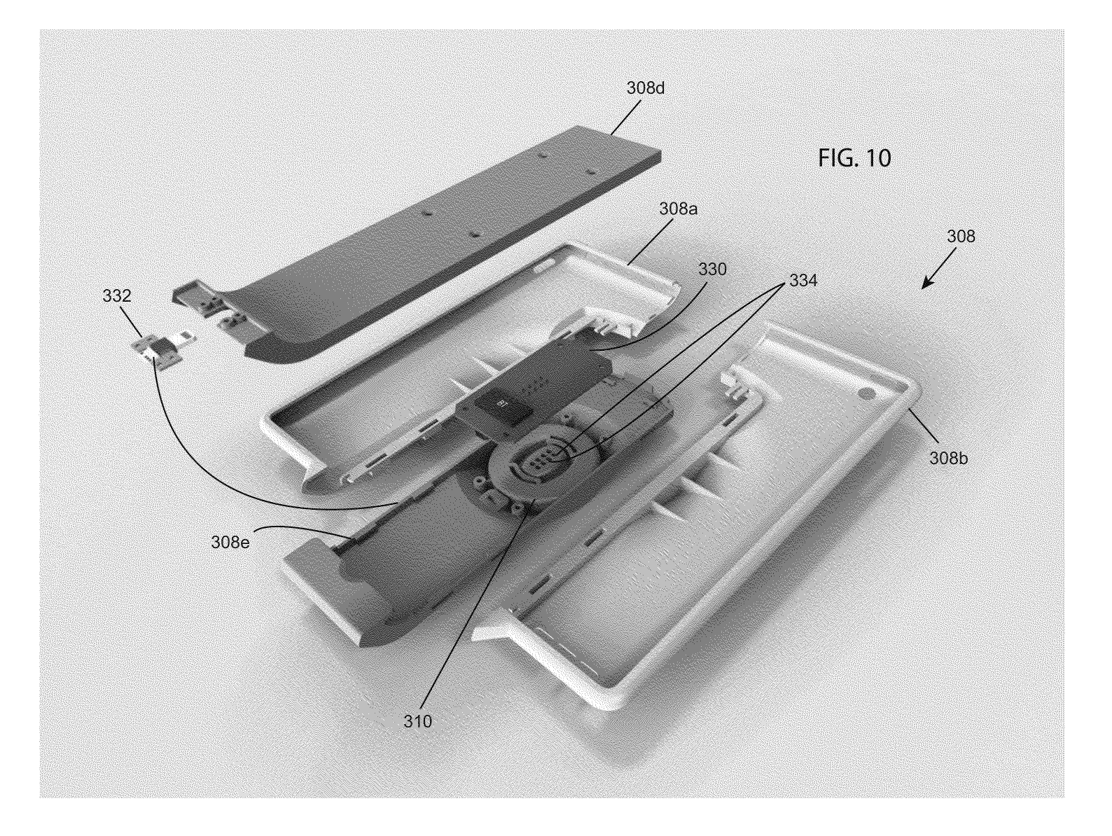

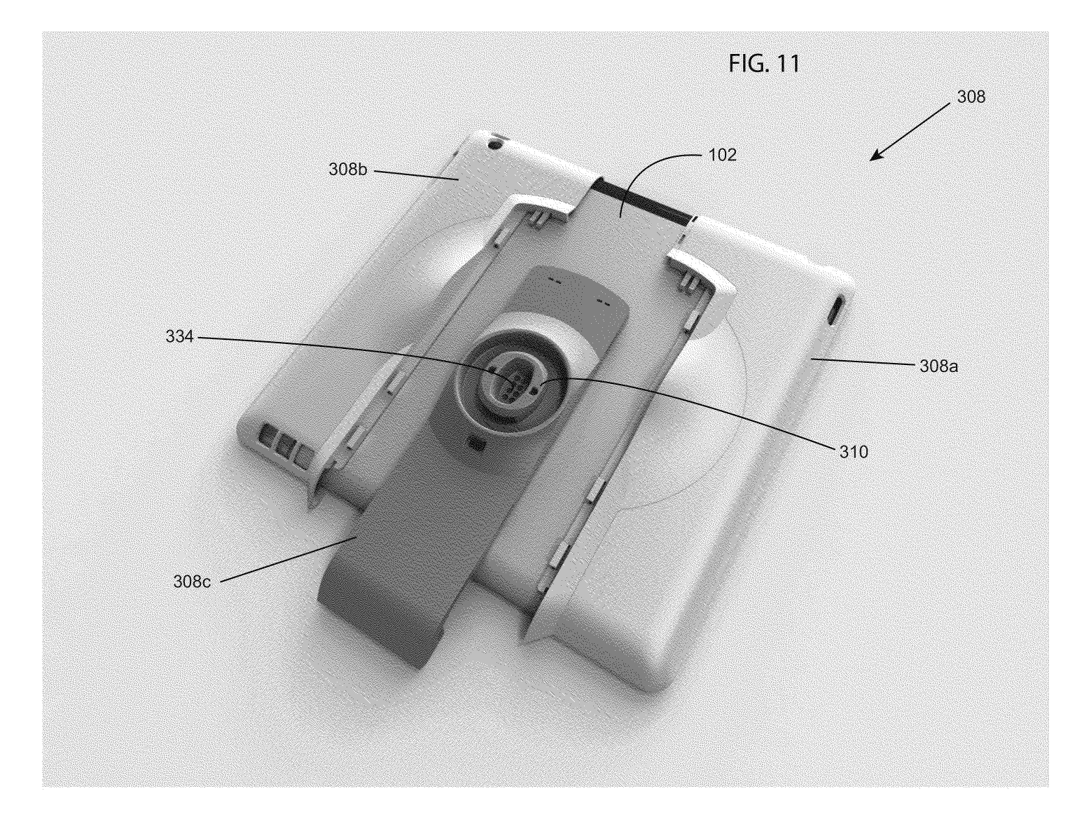

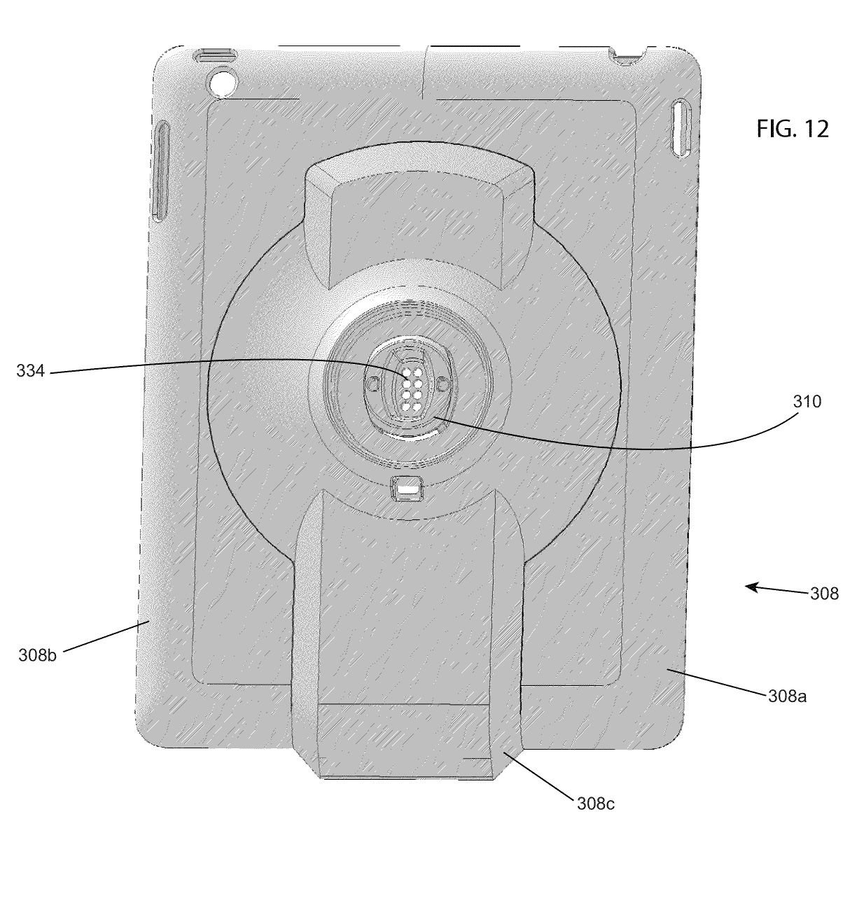

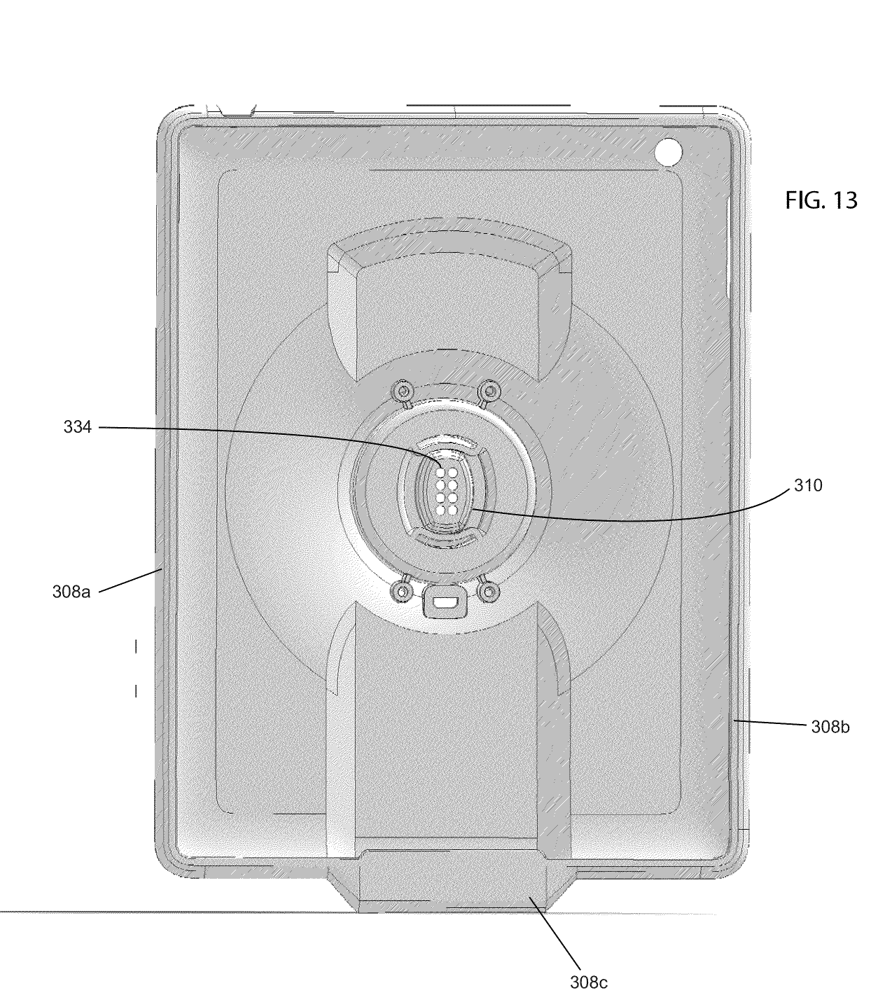

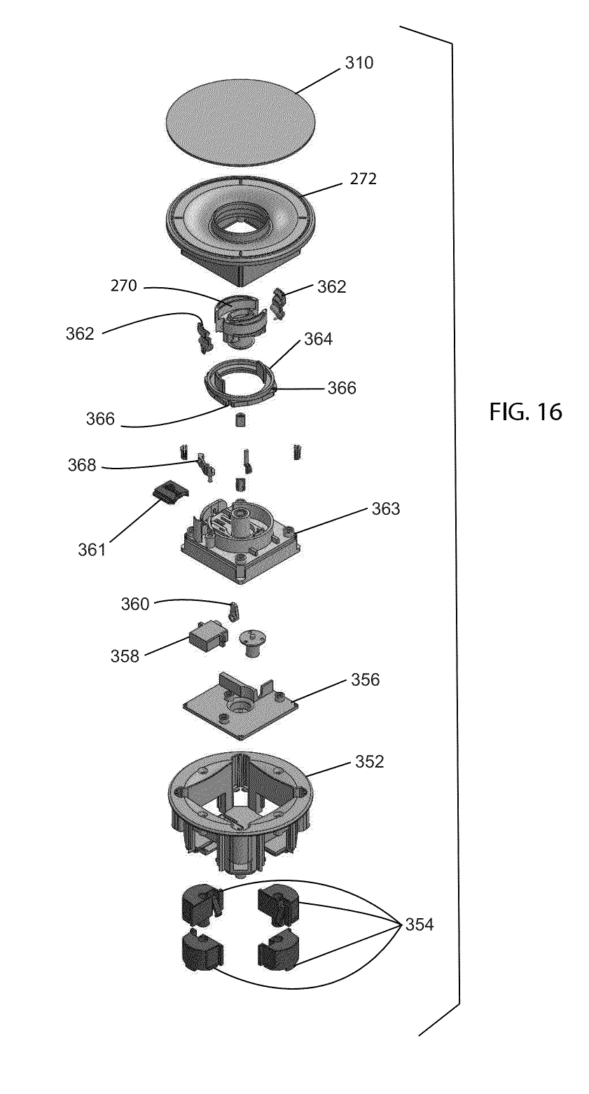

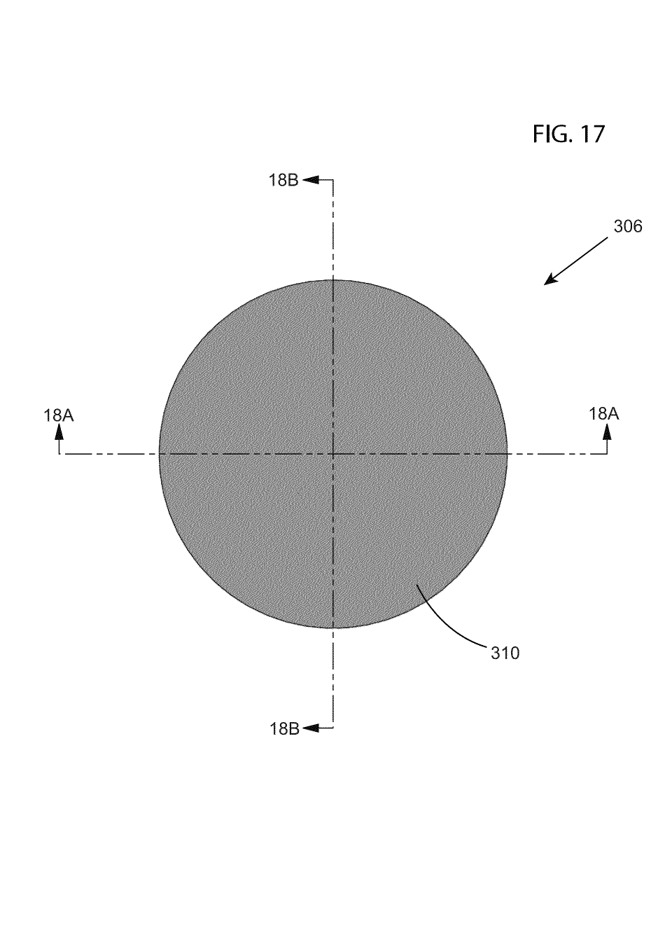

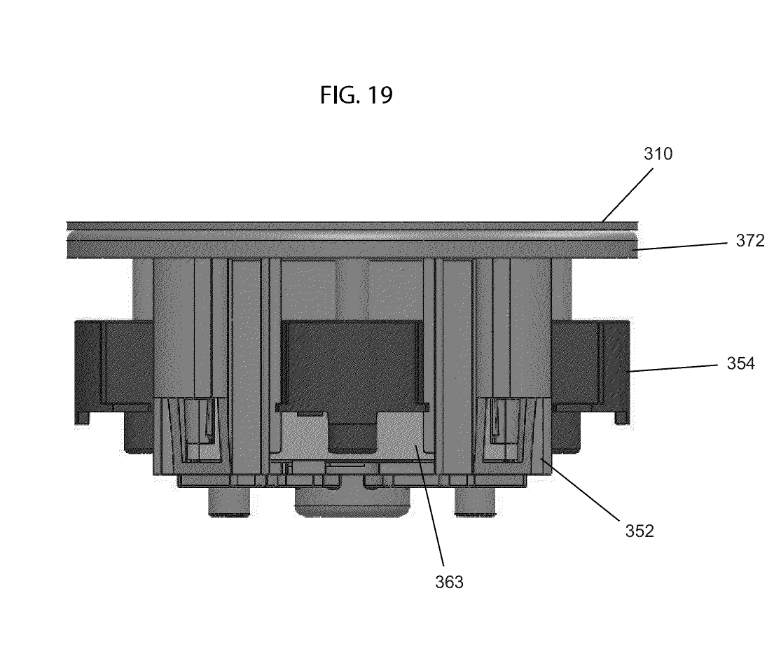

FIGS. 10-19 show another embodiment of a remotely actuated display system in accordance with the invention. In keeping with the above practice, items will use a similar latter two digit reference numeral with the hundreds integer incremented by one to distinguish one embodiment from other. Thus, the cover or case will be referenced using reference numeral 308 instead of 108 as was used with the embodiment of FIGS. 1-5. FIGS. 10-13 show a case 308 that includes a first securing member, such as left portion 308a, a second securing member such as right portion 308b, and a third securing member such as center portion 308c. The center portion 308c has a first portion such as top portion 308d and a second portion such as bottom portion 308e and further includes a hub 310, a controller, such as microcontroller 330, and a device connector 332. The microcontroller 330 and the device connector 332 are captured between the top portion 308d and bottom portion 308e to collectively form the center portion 308c. The hub 310 is formed into the bottom portion 308e and includes a plurality of recesses or openings such as holes 334 that allow pins in the base 102 to engage terminals, such as metalized/solder pads or other suitable connectors in the hub. In a preferred form, the hub 310 further includes geometry that allows the hub to selectively engage the locking mechanism 306.

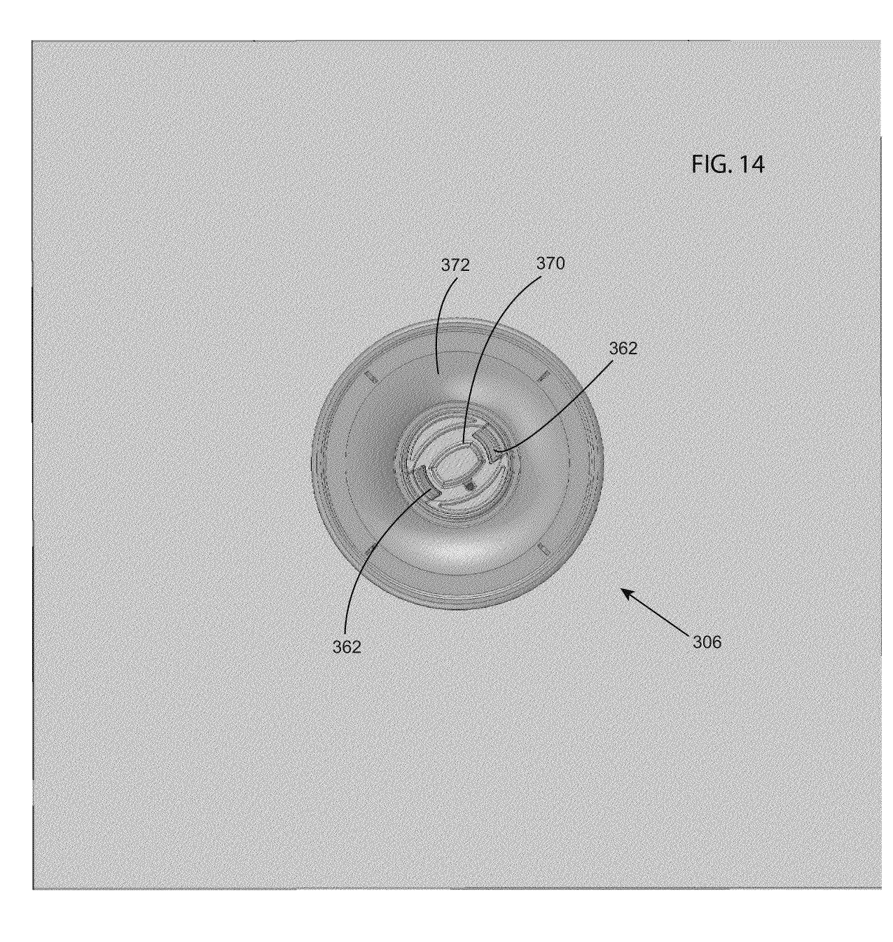

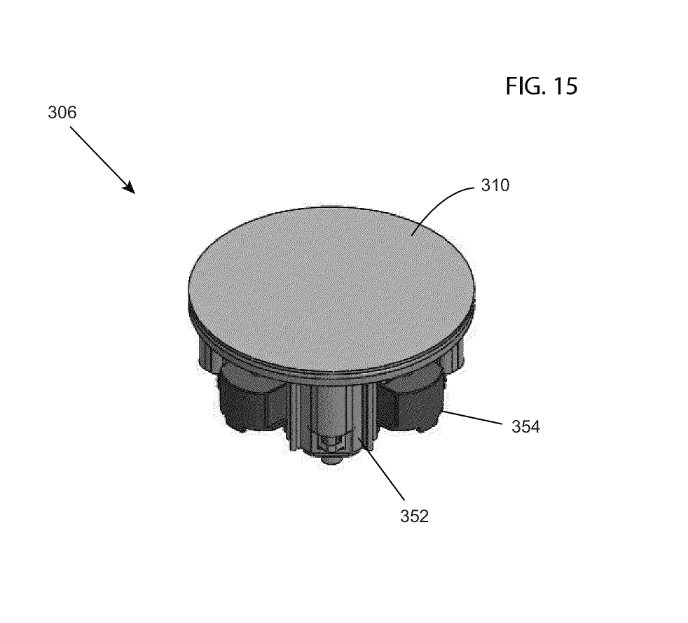

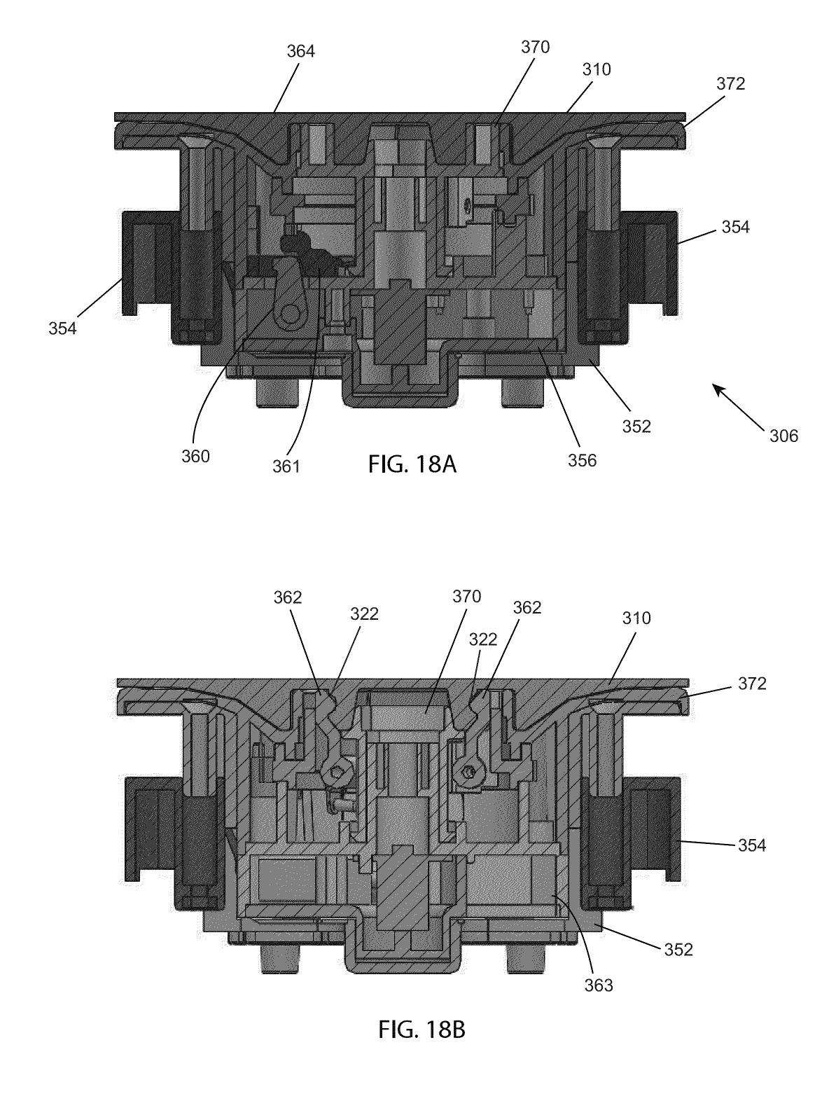

Turning now to FIGS. 14-19, an exemplary embodiment of a locking mechanism 306 in accordance with the invention is shown. The locking mechanism 306 includes a plug base 352 and a plurality of retention clips 354. The retention clips 354 secure the plug base 352 to a surface. In the embodiment shown, the retention clips 354 are removably attached to the plug base 352 by a plurality of fasteners, such as screws, bolts, adhesive, etc. Tightening the fasteners secures the plug base 352 from the surface, and loosening the fasteners allows the plug base 352 to be removed from the surface. A base plate 356 is inserted into the plug base 352 and provides a surface onto which other locking mechanism components are placed. For example, in the embodiment shown, a motor 358 and cam 360 are attached to the base plates. In the form illustrated, the motor 358 is attached to a cam 360 that, when the motor is toggled, moves a spring loaded tab 361, which actuates clamp arms 362 (which operate similar to locking arms 124 and 224 discussed above). As best illustrated in FIGS. 18A-B, the clamp arms 362 engage corresponding recesses in the hub 310 to selectively retain the hub in the locking mechanism 306. For simplicity, only a portion of the hub 310 of cover 308 is illustrated in FIGS. 15-19, but it should be understood that the hub and cover will look like hub 310 and cover 308 as illustrated in FIGS. 10-13 and 18A-B. Thus, corresponding member structures are provided that cooperate with one another to selectively lock and unlock the hub to the base. For example, first mating members such as clamp arms 362 engage second mating members such as recesses 322 (FIG. 18B) in the base to lock the hub to the base. The first mating or locking members are moveable from a first or locked position to a second or unlocked position. As mentioned with respect to prior embodiments, in alternate forms, the mating members may be swapped or interchanged so the hub has locking arms and the base has mating recesses or so that the hub and base have alternating mating structures such as alternating locking arms and recesses.

In the embodiment shown, a plug cover 363 covers the motor 358 and provides a surface into which a bearing ring 364 is inserted. The bearing ring 364 allows the hub 310 to rotate in the locking mechanism 306. The bearing ring includes a plurality of recesses, such as notches or detents 366 that align the hub in a number of predetermined and/or preferred orientations. One or more biased mating structures such as spring loaded cam 368 selectively engage one or more corresponding mating structures, such as the detents 366, when aligned with the cam 368 to hold the hub in place or in that predetermined position or orientation. In the form shown, the detents 366 are positioned at predetermined locations that correspond to orientations deemed most suitable for the display which may change for particular applications. For example, in one form, the detents 366 are positioned so that the display 300 is equipped to hold the electronic device at ninety degree increments corresponding to portrait and landscape orientations. More or fewer predetermined positions may be provided if desired by simply adding or reducing the number of detents 366.

The locking mechanism 306 electrically engages the hub 310 by an outlet 370. The outlet is electrically connected to the motor 358 and has geometry that matches the hub 310 to ensure proper engagement with the outlet 370. A cover, such as receptacle 372, covers the components of the locking mechanism 306 to form a finished looking or polished locking structure like receptacle 112 discussed above with respect to FIGS. 1-5. Like receptacle 112, locking mechanism 306 may be installed into a base similar to bases 104 illustrated in FIGS. 1-5 or alternatively may be directly mounted to a surface (e.g., table, stand, wall, etc.) to conserve space or accommodate certain applications. For example, it is contemplated that bases such as bases 104 illustrated in FIGS. 1-5 will be desirable for displaying consumer electronics in consumer electronic retail stores and/or in hospitality applications in order to tilt the display of the electronic device at an angle desirable for consumer's viewing. This angle may vary depending on the intended consumer (e.g., a smaller angle may be used when adults make-up the majority of consumers and a larger angle may be used when children make-up the majority of consumers). In some forms, the base 104 may be configured to allow the viewing angle of the display of the electronic device (e.g., the device angle itself) to be adjusted with respect to the base 104 for this reason or other reasons. It is also contemplated that the locking mechanism 306 will be provided in a wall mountable version so that the electronic device may be displayed and viewed from a wall. In such embodiments, it may be desirable to allow the viewing angle of the display of the electronic device to be moved with respect to a housing containing the locking mechanism 306 so that the electronic device can be positioned at a desired angle on the wall.

It should be understood that the outlet 370 and mating hub portions may take a variety of different shapes and sizes so long as the shapes are compatible with one another in at least one orientation. For example, in one form, the outlet may be designed so that the hub has to be positioned in a specific orientation to mate with the outlet such as in cases where a polarized connection is desired. In other forms, the outlet 370 and mating hub portion may be symmetrical (as shown) so that the hub 310 can be installed on the locking mechanism 306 more easily and/or in more than one orientation.

In the form of locking mechanism 306 illustrated in FIGS. 10-19, a multi-stage locking device is provided that includes an initial or first locking position wherein the hub 310 is secured or connected to the locking mechanism 306 and structure the locking mechanism is connected to (e.g., base 304, wall, etc.) but still rotatable with respect the locking mechanism 306, and a second locking position wherein the hub 310 is secured to the locking mechanism 306 and cannot be rotated or moved with respect to the locking mechanism 306. For example, when the hub 310 is connected to the locking mechanism 306, the spring biased locking mechanisms or arms 362 are moved over or pivoted open to fit the lip or shoulder of hub 310 and then biased back closed to engage the recesses of the hub 310. At this point, the hub 310 and cover 308 are secured to the locking mechanism 306, but are still capable of being rotated with respect to the locking mechanism 306. As the hub 310 is pressed further onto the locking mechanism 306 and base 304 to cause the terminal pins of the locking mechanism to engage the terminals or lands positioned on the circuit board of hub 310 to complete or electrically connect the circuit between the hub 310 and locking mechanism 306, the cam 360 is rotated causing the bearing ring 364 to move linearly upward so that protrusions extending from the bearing ring 364 fill the gap or space located between the outer surfaces of locking arms 362 and the cover or receptacle 372 (as best seen in FIG. 18B) to exert more clamping force between locking arms 362 and hub 310 so that the hub 310 and cover 308 are no longer rotatable with respect to the locking mechanism 306 and base 304.

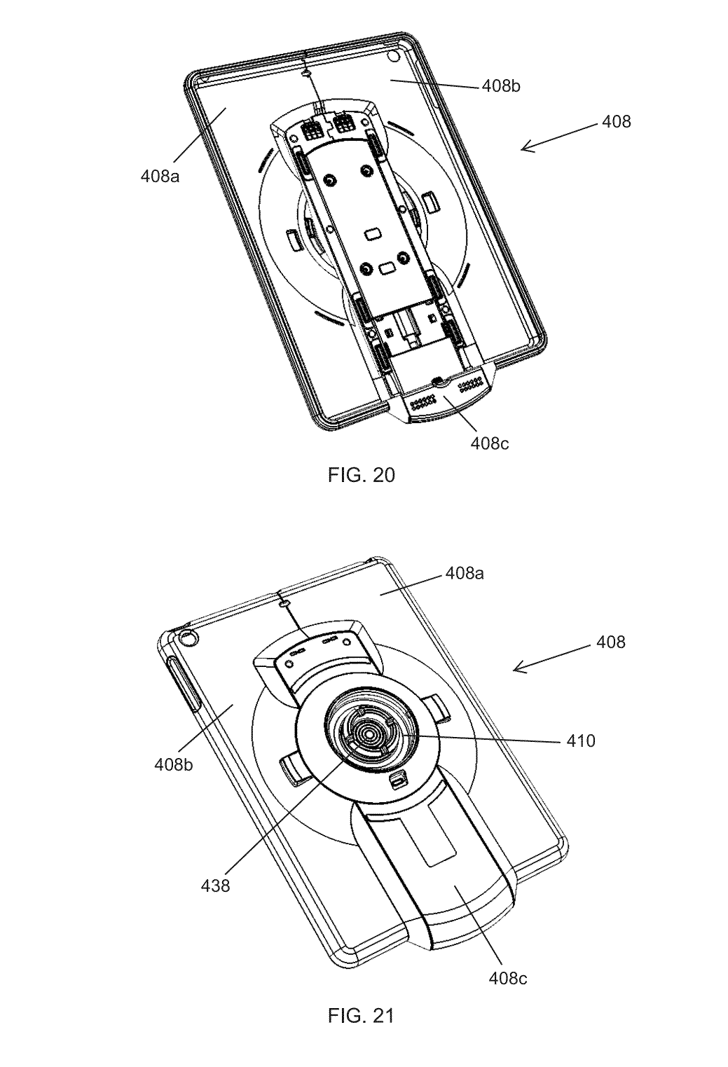

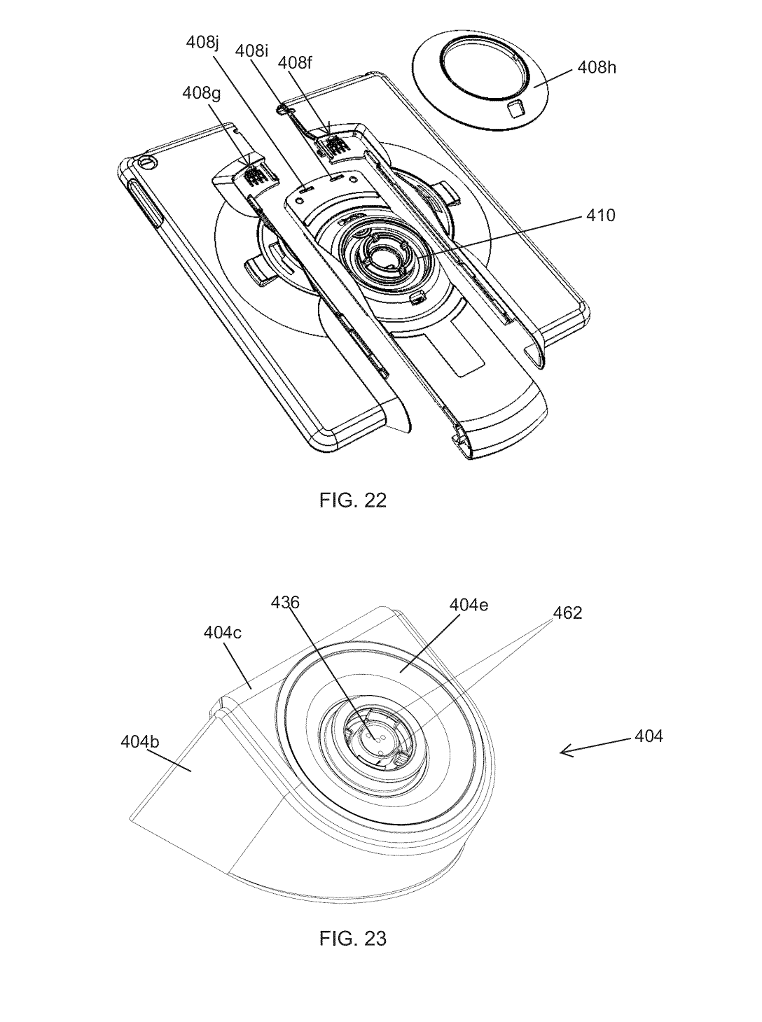

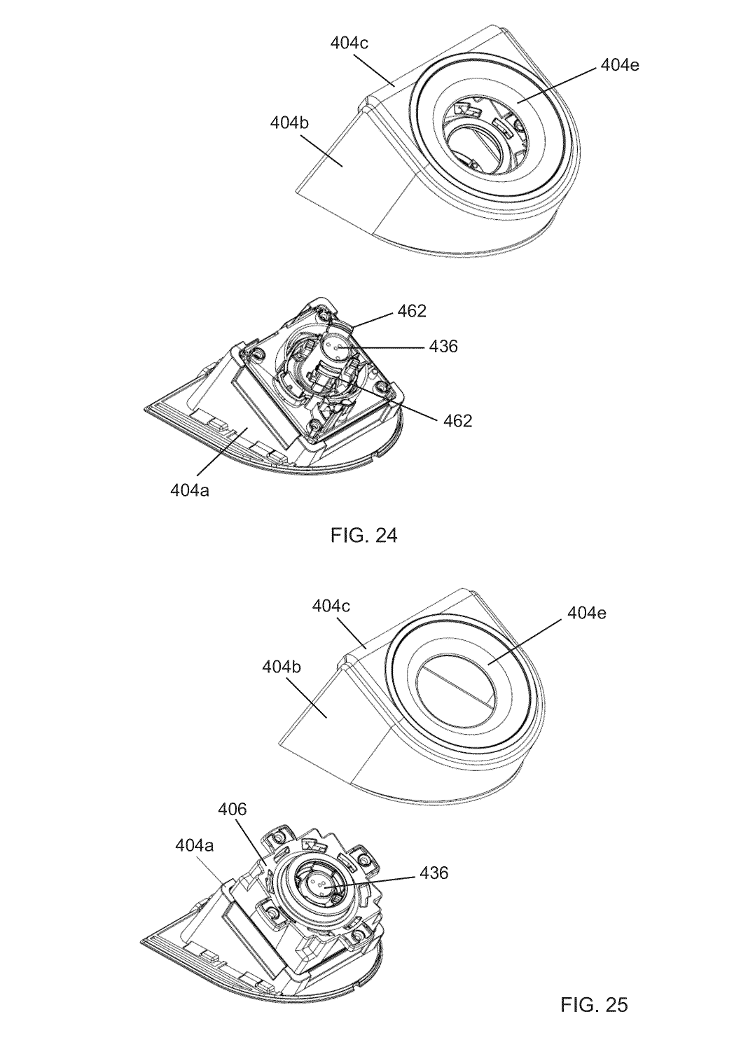

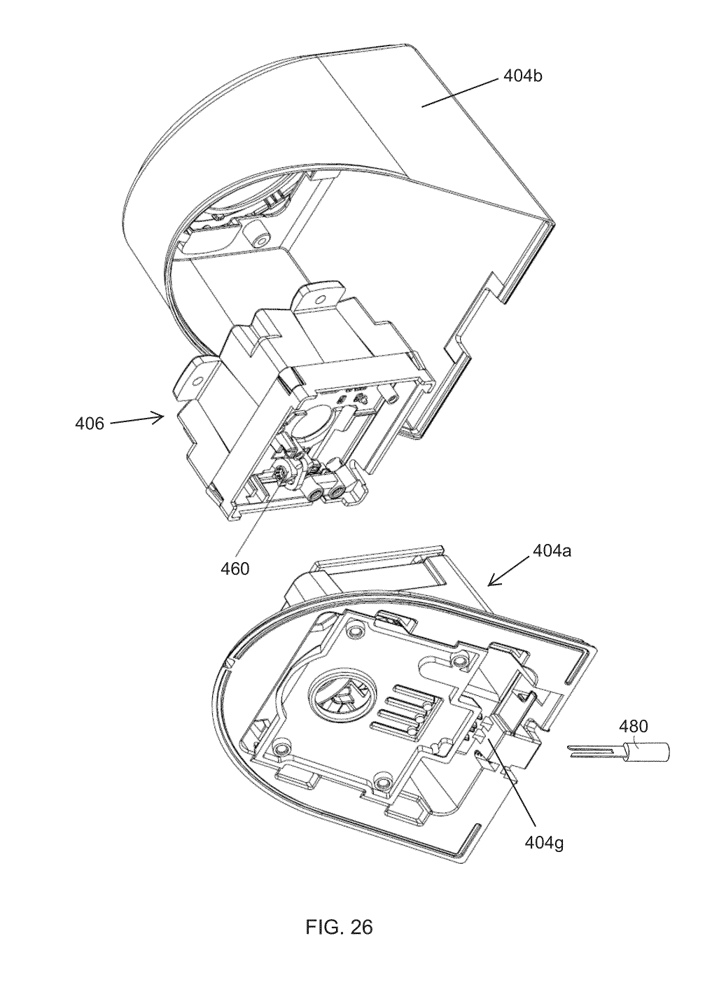

Yet another embodiment of the security solution or display is illustrated in FIGS. 20-27. In keeping with the above practice, items that are similar to those discussed above will use reference numerals with similar latter two digit reference numerals, but the hundreds integer will be incremented by one. Thus, the security solution of FIGS. 20-27 is referred to generally as 400, rather than 100 or 300 as is used above. In the form illustrated, the security solution 400 includes a multi-piece cover 408 for covering and securing a portable electronic device to a display. Cover 408 includes first portion 408a, second portion 408b and third portion 408c. The cover portions are connected by placing the first and second portions 408a, 408b about the portable electronic device to be secured and sliding the third portion 408c into the opening defined between the first and second portions 408a, 408b. In a preferred form, the third portion 408c connects the first and second portions 408a, 408b to one another and the third portion 408c is secured to the first and second portions 408a, 408b via mating structures, such as mating finger members 408f, 408g, and hub cover or bezel 408h which is snap fit onto the cover 408. To remove the cover 408 from the device, the hub cover or bezel 408h is removed first and then a tool is inserted into openings 408i, 408j over third cover portion 408c in order to depress mating finger members 408f, 408g so that the third cover portion 408c can be slid out of engagement with the first and second cover portions 408a, 408b.

In a preferred form, the cover 408 is configured for a specific product or type of product so that the cover defines specific openings that correspond to inputs located on the electronic device (e.g., volume controls, power switches, cameras, audio jacks, USB or other ports, memory card slots, home buttons, speaker openings, etc.). For example, in some forms cover portions may be provided for a particular brand of product and even a specific model. The pin out of the hub 410 may also vary from cover to cover. In other forms, generic cover portions are designed with general openings defined in areas to accommodate various brands and/or models of electronic devices. In a preferred form, only the third cover portion 408c will need to be changed in order for the cover 408 to be used with a variety of different devices. For example, in preferred forms, only the center portion 408c will need to be changed in order to use cover 408 with multiple brands or models of electronic devices. The center portion 408c includes hub 410 and can be changed to use a second type of hub 410 (e.g., a hub with a different pin out and/or socket configuration) with the cover so that the cover 408 can be used to secure a second type of portable electronic device.

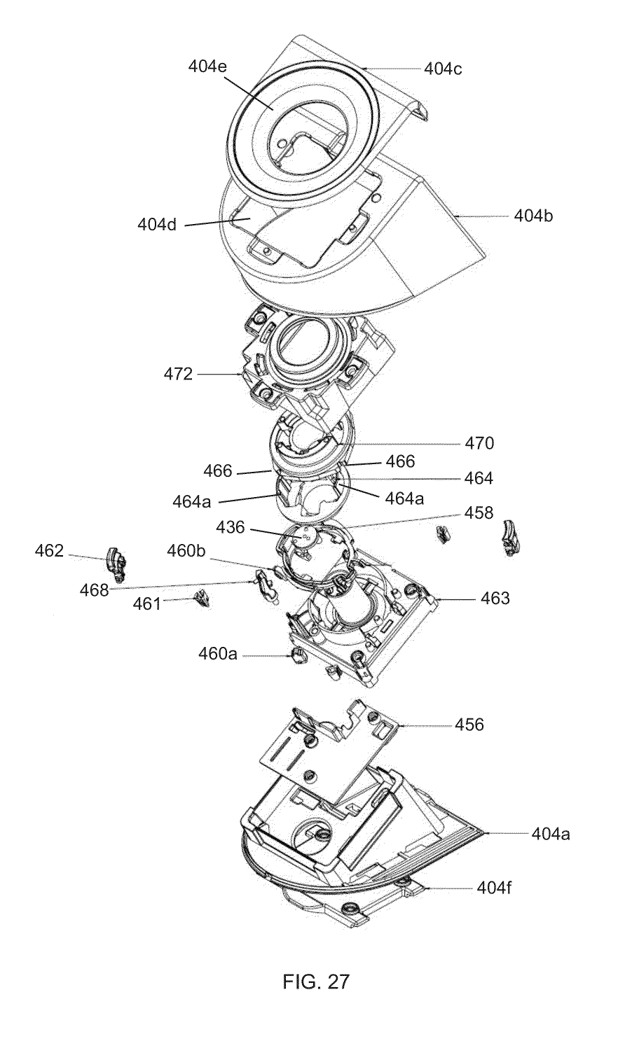

In FIGS. 23-27 an alternate locking mechanism 406 and base 404 are illustrated for use with the cover 408 of FIGS. 20-22. In a preferred form, the base includes a lower or first portion 404a that is secured to a work surface and to which the locking mechanism 406 is secured, an intermediate or second portion 404b that covers the lower portion 404a and defines an opening or recess 404d within which the locking mechanism 406 is disposed or inserted (see FIG. 27). The base 404 further includes an upper or third portion 404c which covers the intermediate portion 404b and locking mechanism 406 (once inserted in recess 404d). The upper portion 404c defines a funnel shaped opening 404e that helps guide the hub 410 of cover 408 into proper alignment with locking mechanism 406 and base 404. Other designs, such as a tapered opening (e.g., a linearly tapered opening, etc.) could be used for this purpose in alternative embodiments. In a preferred form, the base 404 also includes a mount 404f, which could be a mounting plate, a rubber foot member or the like, and defines openings 404g that a tool 480 may be inserted into to disconnect the second and third base cover portions 404b, 404c from the first base portion 404a to provide access to the fasteners that mount the first portion 404a to a surrounding work surface. Such a tool and connection/disconnection structure and method are disclosed in Applicant's U.S. Pat. No. 8,191,851, issued to Crown on Jun. 5, 2012, which is incorporated herein by reference in its entirety. This configuration allows the fasteners to be hidden beneath the base cover 404b and/or 404c so that the display 400 presents cleanly and artistically without fasteners being visible. Such a clean display keeps the consumer's eyes focused on the product being displayed rather than on the anti-theft security solution or display.

The remainder of the components that make-up base 404 and locking mechanism 406 and operation of same are similar to those discussed above with respect to FIGS. 10-19 and, thus, will not be repeated here for purposes of brevity. These components have been numbered using similar latter two-digit reference numerals, but including the prefix 4 instead of 3 for purposes of distinguishing one embodiment from another. When the hub 410 of cover 408 is inserted into funnel opening 404f, the spring biased locking members 462 secure the hub 410 and cover 408 (and associated electronic device these items are connect to) to the locking mechanism 406, but in such a way as to allow the cover 408, hub 410 and device associated with these items to be rotated with respect to the locking mechanism 406 and base 404. If the cover 408 and hub 410 are pressed onto the base 404 and locking mechanism 406 further, the target terminals 438 engage the depressible pins 436 of locking mechanism 406 to complete the circuit between the locking mechanism 406 and cover 408 (in particular the hub 410) which causes the solenoid 458 to move the cam 460 and linearly drive the key feature, such as protrusions 464a of bearing plate or ring 464, through openings in outlet member 470 and into the gap that exists between the outer surfaces of the spring biased locking members 462 and the surrounding cover or receptacle 472 (in the same manner as that shown in FIG. 18B for the embodiment of FIGS. 10-19). Thus, the locking mechanism 406 is a multi-position or multi-stage locking mechanism capable of being moved between an unlocked position, a first locked position wherein the hub 410 is secured to the locking mechanism 406 but yet rotatable with respect to the locking mechanism and a second locked position wherein the hub is secured to the locking mechanism 406 and not rotatable with respect to the locking mechanism.

Thus, there have been provided numerous embodiments in accordance with the invention disclosed herein. For example, a remotely actuated display system has been disclosed having a base for securely mounting a device and including a receptacle and a locking mechanism, the receptacle removably attached to an electric power source, a case removeably attached to an electronic device and including a hub which is removably attached to the receptacle, the hub including a controller communicatively attached to the electronic device and further including a plurality of recesses for receiving at least a portion of the locking mechanism, and the electronic device including a software application for controlling the locking mechanism. The remotely actuated display system may include a completed electronic circuit once the hub is attached to the receptacle, with the completed electronic circuit including an electronic switch that locks the hub to the base. The electronic switch and circuit may include an actuator for driving the locking mechanism into a locked position wherein the hub is secured to the base. The case of the remotely actuated display system may include a three piece structure with first and second case portions interconnected via a third case portion. In one form, the first and second case portions define lock members that engage corresponding structures on the third case portion. The third case portion may define lock openings aligned with the lock members of the first and second case portions so that the a tool may be inserted into the lock openings to unlock the lock members of the first and second case portions so that the third case portion may be removed from the first and second case portions. The software application and controller of the remotely actuated display system may also generate an unlock command upon entry of an authorized input which unlocks the locking mechanism so that the hub and case may be removed from the base.

In other forms, a remotely actuated display or security solution apparatus has been disclosed having a cover for covering at least a portion of a portable electronic device, a locking mechanism having a body and at least one lock, the lock being moveable between a locked position and unlocked position via a control interface for use by a user to interact with the remotely actuated display or security solution apparatus, and a controller configured to unlock the locking mechanism in response to an authorized input being entered on the control interface. The cover may include a hub having a device connector for connecting to a port on the portable electronic device and the locking mechanism including a receptacle for receiving the hub and powering the device connector once the hub is disposed within the receptacle. The locking mechanism may include a multi-staged locking mechanism moveable between an unlocked position, a first locked position wherein at least a portion of the cover is secured to the locking mechanism but remains rotatable with respect to the locking mechanism, and a second locked position wherein the at least a portion of the cover is secured to the locking mechanism and is not rotatable with respect to the locking mechanism. The remotely actuated display or security solution apparatus may also include a base within which the locking mechanism is disposed, the base being mountable to a work surface and capable of positioning the cover in a predetermined position or orientation. In some forms, at least one of the base and locking mechanism define mating structures for positioning and holding the cover in a plurality of predetermined positions or orientations. In one embodiment, the mating structures comprise male and female structures that engage one another when the cover is in one of the plurality of predetermined positions or orientations. Alternatively, the remotely actuated display or security solution apparatus may include a base within which the locking mechanism is disposed and tool having at least one protrusion for inserting through an opening defined by the base to remove at least a portion of the base and provide access to fasteners securing at least one of the base and locking mechanism to a work surface.

In other forms, an apparatus for remotely actuating a display or security solution apparatus lock is provided including a control interface for use by a user to interact with a computer application, and a processor based system configured to run the software application, receive information form the control interface, analyze the received information, determine if the user is an authorized user from the analyzed information, and allowing the user to remotely actuate the display or security solution apparatus lock if the user is determined to be an authorized user.

While the embodiments discussed up to now disclose a variety of different apparatus, it should be understood that various methods are disclosed herein as well. For example, a method of securing a portable electronic device is disclosed herein. In one form, the method includes remotely actuating the lock via software on the electronic device. In another form, the method includes providing a multi-stage locking mechanism moveable between an unlocked position, a first locking position wherein the electronic device or device cover are secured to the locking mechanism but remain rotatable with respect to the locking mechanism, and a second locking position wherein the electronic device or device cover are secured to the locking mechanism and not rotatable with respect to the locking mechanism. Methods of manufacturing and assembling a security solution are also disclosed herein, as are methods of securing a portable electronic device to a locking mechanism, base or anchor.

In addition, a method for securing a hub or cover portion to a locking mechanism is disclosed herein which includes providing a hub or cover portion for connecting to an electronic device, a locking mechanism defining a receptacle for receiving at least a portion of the hub or cover and moveable between a locked position wherein the hub or cover is secured to the locking mechanism and an unlocked position wherein the hub or cover are freely removable from the locking mechanism, and a control interface for use by a user to interact with the locking mechanism, and moving the locking mechanism to the unlocked position when a user enters an authorized input via the control interface.

A method for securing a portable electronic device connector to a locking mechanism is also disclosed which includes providing a portable electronic device connector and locking mechanism, and remotely actuating the locking mechanism via a control interface for use by the user to interact with the locking mechanism. The method may further include installing the control interface on the portable electronic device connected to the portable electronic device connector. In some forms, the control interface is an app or software application installed on the portable electronic device and the method further comprises remotely actuating the locking mechanism via the app. The locking mechanism may be a multi-stage locking mechanism moveable between an unlocked position, a first locking position wherein the electronic device or device connector are secured to the locking mechanism but remain rotatable with respect to the locking mechanism, and a second locking position wherein the electronic device or device connector are secured to the locking mechanism and not rotatable with respect to the locking mechanism, with the method further comprising actuating the locking mechanism by moving the locking mechanism to any one of the unlocked position, first locking position or second locking position.

A method for remotely actuating a display or security solution apparatus lock using a software application is also disclosed including running the software application, receiving information from a control interface used by a user to interact with the software application, analyzing the received information, determining if the user is an authorized user from the analyzed information, and allowing the user to remotely actuate the display or security solution apparatus lock if the user is determined to be an authorized user.

A storage medium storing a computer program executable by a processor based system is also disclosed with the computer program causing the processor based system to execute steps including running a software application, receiving information from a control interface used by a user to interact with the software application, analyzing the received information, determining if the user is an authorized user from the analyzed information, and allowing the user to remotely actuate a display or security solution apparatus lock if the user is determined to be an authorized user.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A remotely actuated display system comprising:
a base for securely mounting a device and including a receptacle and a locking mechanism;
the receptacle removably attached to an electric power source;
a case removeably attached to an electronic device and including a hub which is removably attached to the receptacle;
the hub including a controller communicatively attached to the electronic device and further including a plurality of recesses for receiving at least a portion of the locking mechanism; and
the electronic device including a software application for controlling the locking mechanism.

2. The remotely actuated display system of claim 1 comprising a completed electronic circuit once the hub is attached to the receptacle, the completed electronic circuit including an electronic switch that locks the hub to the base.

3. The remotely actuated display system of claim 2 wherein the electronic switch and circuit include an actuator for driving the locking mechanism into a locked position wherein the hub is secured to the base.

4. The remotely actuated display system of claim 1 wherein the case has a three piece structure with first and second case portions interconnected via a third case portion.

5. The remotely actuated display system of claim 4 wherein the first and second case portions define lock members that engage corresponding structures on the third case portion.

6. The remotely actuated display system of claim 5 wherein the third case portion defines lock openings aligned with the lock members of the first and second case portions so that the a tool may be inserted into the lock openings to unlock the lock members of the first and second case portions so that the third case portion may be removed from the first and second case portions.

7. The remotely actuated display system of claim 1 wherein the software application and controller generate an unlock command upon entry of an authorized input which unlocks the locking mechanism so that the hub and case may be removed from the base.

8. A remotely actuated display or security solution apparatus comprising:
a cover for covering at least a portion of a portable electronic device;
a locking mechanism having a body and at least one lock, the lock being moveable between a locked position and unlocked position via a control interface for use by a user to interact with the remotely actuated display or security solution apparatus; and
a controller configured to unlock the locking mechanism in response to an authorized input being entered on the control interface.

9. The remotely actuated display or security solution apparatus of claim 8 wherein the cover includes a hub having a device connector for connecting to a port on the portable electronic device and the locking mechanism including a receptacle for receiving the hub and powering the device connector once the hub is disposed within the receptacle.

10. The remotely actuated display or security solution apparatus of claim 8 wherein the locking mechanism is a multi-staged locking mechanism moveable between an unlocked position, a first locked position wherein at least a portion of the cover is secured to the locking mechanism but remains rotatable with respect to the locking mechanism, and a second locked position wherein the at least a portion of the cover is secured to the locking mechanism and is not rotatable with respect to the locking mechanism.

11. The remotely actuated display or security solution apparatus of claim 8 further comprising a base within which the locking mechanism is disposed, the base being mountable to a work surface and capable of positioning the cover in a predetermined position or orientation.

12. The remotely actuated display or security solution apparatus of claim 11 wherein at least one of the base and locking mechanism define mating structures for positioning and holding the cover in a plurality of predetermined positions or orientations.

13. The remotely actuated display or security solution apparatus of claim 12 wherein the mating structures comprise male and female structures that engage one another when the cover is in one of the plurality of predetermined positions or orientations.

14. The remotely actuated display or security solution apparatus of claim 8 further comprising a base within which the locking mechanism is disposed and tool having at least one protrusion for inserting through an opening defined by the base to remove at least a portion of the base and provide access to fasteners securing at least one of the base and locking mechanism to a work surface.

15. A method for securing a hub or cover portion to a locking mechanism comprising:
providing a hub or cover portion for connecting to an electronic device, a locking mechanism defining a receptacle for receiving at least a portion of the hub or cover and moveable between a locked position wherein the hub or cover is secured to the locking mechanism and an unlocked position wherein the hub or cover are freely removable from the locking mechanism, and a control interface for use by a user to interact with the locking mechanism; and
moving the locking mechanism to the unlocked position when a user enters an authorized input via the control interface.

16. A method for securing a portable electronic device connector to a locking mechanism comprising:
providing a portable electronic device connector and locking mechanism; and
remotely actuating the locking mechanism via a control interface for use by the user to interact with the locking mechanism.

17. The method of claim 16 further comprising installing the control interface on the portable electronic device connected to the portable electronic device connector.

18. The method of claim 17 wherein the control interface is an app installed on the portable electronic device and the method further comprises remotely actuating the locking mechanism via the app.

19. The method of claim 16 wherein the locking mechanism is a multi-stage locking mechanism moveable between an unlocked position, a first locking position wherein the electronic device or device connector are secured to the locking mechanism but remain rotatable with respect to the locking mechanism, and a second locking position wherein the electronic device or device connector are secured to the locking mechanism and not rotatable with respect to the locking mechanism, the method further comprising actuating the locking mechanism by moving the locking mechanism to any one of the unlocked position, first locking position or second locking position.

20. A method for remotely actuating a display or security solution apparatus lock using a software application comprising:
running the software application;
receiving information from a control interface used by a user to interact with the software application;
analyzing the received information;
determining if the user is an authorized user from the analyzed information; and
allowing the user to remotely actuate the display or security solution apparatus lock if the user is determined to be an authorized user.

21. A storage medium storing a computer program executable by a processor based system, the computer program causing the processor based system to execute steps comprising:
running a software application;
receiving information from a control interface used by a user to interact with the software application;
analyzing the received information;
determining if the user is an authorized user from the analyzed information; and
allowing the user to remotely actuate a display or security solution apparatus lock if the user is determined to be an authorized user.

22. An apparatus for remotely actuating a display or security solution apparatus lock comprising:
a control interface for use by a user to interact with a computer application; and
a processor based system configured to run the software application, receive information form the control interface, analyze the received information, determine if the user is an authorized user from the analyzed information, and allowing the user to remotely actuate the display or security solution apparatus lock if the user is determined to be an authorized user.
